(19) United States
(12) Patent Application Publication
(10) Pub. No.: US 2023/0409288 A1
(43) Pub. Date: Dec. 21, 2023

(54) PROCESSING CIRCUIT, LOGIC GATE, ARITHMETIC PROCESSING METHOD, AND NON-TRANSITORY COMPUTER-READABLE STORAGE MEDIUM

(71) Applicants: TOHOKU UNIVERSITY, Sendai-shi (JP); CANON MEDICAL SYSTEMS CORPORATION, Tochigi (JP)

(72) Inventors: Takahiro HANYU, Sendai-shi (JP); Naoya ONIZAWA, Sendai-shi (JP); Seiichi SHIN, Moriya-shi (JP); Hiroyuki FUJITA, Toshima-ku (JP); Koji YANO, Setagaya-ku (JP)

(73) Assignees: TOHOKU UNIVERSITY, Sendai-shi (JP); CANON MEDICAL SYSTEMS CORPORATION, Tochigi (JP)

(21) Appl. No.: 18/337,833

(22) Filed: Jun. 20, 2023

(30) Foreign Application Priority Data
Jun. 20, 2022 (JP) 2022-099193

(51) Int. Cl. G06F 7/575; G06F 7/58

(52) U.S. Cl. CPC G06F 7/575; G06F 7/58

(57) ABSTRACT

A processing circuit according to an embodiment includes a plurality of logic gates in combination each of which is configured to probabilistically determine, based on signal values of one or two or more input nodes and output nodes at a certain time, signal values at at least one of the input nodes and the output nodes at a subsequent time, in which the processing circuit controls the signal values based on a relationship to be satisfied between at least some nodes of the input nodes and the output nodes.

### CROSS-REFERENCE TO RELATED APPLICATIONS

This application is based upon and claims the benefit of priority from Japanese Patent Application No. 2022-099193, filed on Jun. 20, 2022; the entire contents of which are incorporated herein by reference.

### FIELD

Embodiments disclosed herein relate generally to a processing circuit, a logic gate, an arithmetic processing method, and a non-transitory computer readable storage medium.

### BACKGROUND

As an approach to solving the inverse problem, a method of using invertible logic gates is employed. Invertible logic gates are elements that operate by updating signal values of nodes according to a Hamiltonian defined for each gate, so that after a sufficient time has elapsed, a state of the signal values of the nodes satisfies the minimum energy state defined by the Hamiltonian with a high probability.

On the other hand, in circuits combining invertible logic gates, the signal values of the nodes may be trapped in a local minimum energy state during time evolution and unable to escape, resulting in failure to transition to a global minimum energy state that is the true calculation result.

### BRIEF DESCRIPTION OF THE DRAWINGS

FIG. 1 is a diagram illustrating an example of a configuration of a processing circuit 150 according to an embodiment;

FIG. 2 is a diagram illustrating an example of the arrangement of nodes in the processing circuit 150 according to the embodiment;

FIG. 3 is a diagram illustrating examples of devices connected to the processing circuit 150 according to the embodiment;

FIG. 4 is a diagram illustrating an example of an invertible logic gate according to the embodiment;

FIG. 5 is a diagram illustrating an example of an invertible logic gate according to the embodiment;

FIG. 6 is a diagram illustrating an example of an invertible logic gate according to the embodiment;

FIG. 7 is a flowchart illustrating an example of a flow of calculation processing using the invertible logic gate according to the embodiment;

FIG. 8 is a flowchart detailing a flow of processing at step S200 in FIG. 7;

FIG. 9 is a diagram illustrating an example of processing performed by the invertible logic gate according to the embodiment;

FIG. 10 is a diagram illustrating an example of processing performed by the processing circuit 150 according to the embodiment;

FIG. 11 is a flowchart illustrating a flow of processing performed by the processing circuit 150 according to the embodiment;

FIG. 12 is a diagram detailing processing performed by the processing circuit 150 according to the embodiment;

FIG. 13 is a diagram illustrating an example of a result of calculation performed by the processing circuit 150 according to the embodiment; and

FIG. 14 is a diagram illustrating an example of the result of calculation performed by the processing circuit 150 according to the embodiment.

### DETAILED DESCRIPTION

A processing circuit provided in one aspect of the present embodiment is formed in combination of a plurality of logic gates each of which probabilistically determines, based on signal values of one or two or more input nodes and output nodes at a certain time, signal values at at least one of the input nodes and the output nodes at a subsequent time, in which the processing circuit controls the signal values based on a relationship to be satisfied between at least some nodes of the input nodes and the output nodes.

### Embodiment

Hereinbelow, an embodiment of a processing circuit, a logic gate, an arithmetic processing method, and a computer program will be described in detail with reference to the drawings.

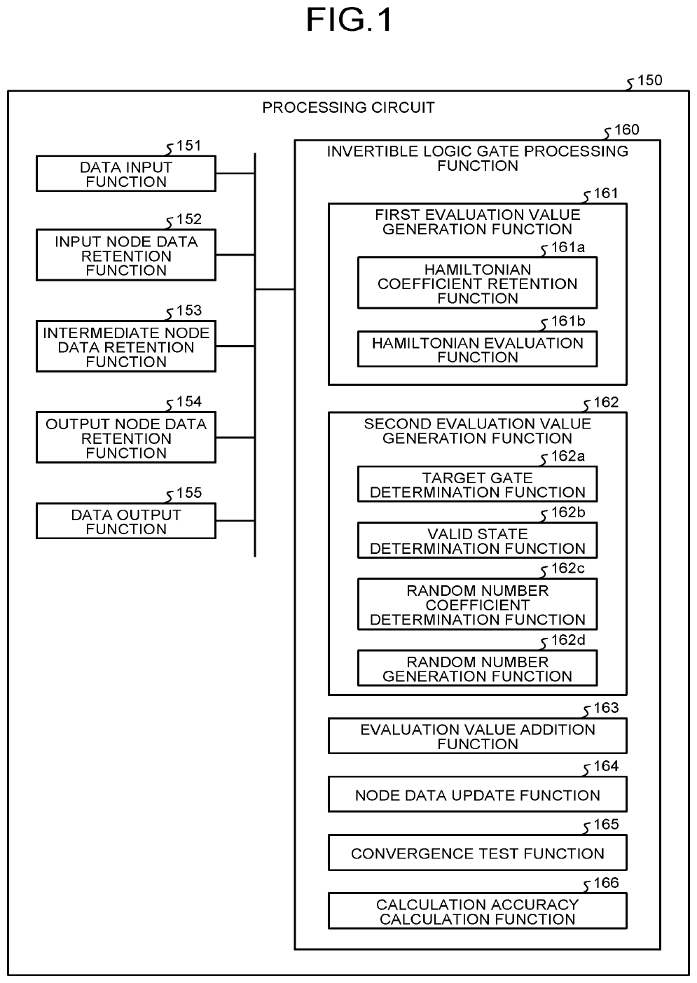

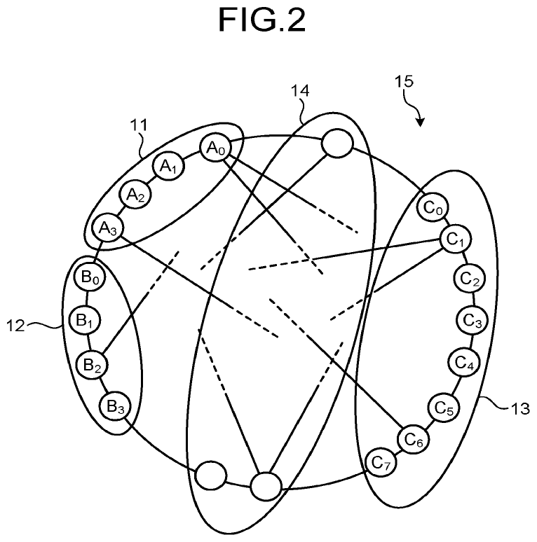

In FIG. 1, an example of a configuration of a processing circuit 150 according to an embodiment is illustrated. The processing circuit 150 is a processing circuit that is capable of solving inverse problems with invertible logic gates described later and has one or two or more invertible logic gates, which serve as input nodes, intermediate nodes, and output nodes, as the entire processing circuit. In FIG. 2, a specific example is illustrated with a case in which an invertible multiplication circuit 15 serves as the processing circuit 150 according to the embodiment, and in this case, the invertible multiplication circuit 15 serving as the processing circuit 150 has input nodes 11 and 12, intermediate nodes 14, and output nodes 13. That is, each of A₀ to A₃, B₀ to B₃, and C₀ to C₇ in FIG. 2 is a node in the invertible multiplication circuit 15 serving as the processing circuit 150. The invertible multiplication circuit 15 serving as the processing circuit 150 is composed of a plurality of the invertible logic gates as a whole. Here, each of the invertible logic gates is implemented by a plurality of the nodes and connections therebetween, as well as predetermined control functions described later.

Returning to FIG. 1, the processing circuit 150 has individual functions of: a data input function 151, an input node data retention function 152, an intermediate node data retention function 153, an output node data retention function 154, a data output function 155, and an invertible logic gate processing function 160. The invertible logic gate processing function 160 has a first evaluation value generation function 161, a second evaluation value generation function 162, an evaluation value addition function 163, a node data update function 164, a convergence test function 165, and a calculation accuracy calculation function 166. The first evaluation value generation function 161 has a Hamiltonian coefficient retention function 161a and a Hamiltonian evaluation function 161b. The second evaluation value generation function 162 has a target gate determination function 162a, a valid state determination function 162b, a random number coefficient determination function 162c, and a random number generation function 162d.

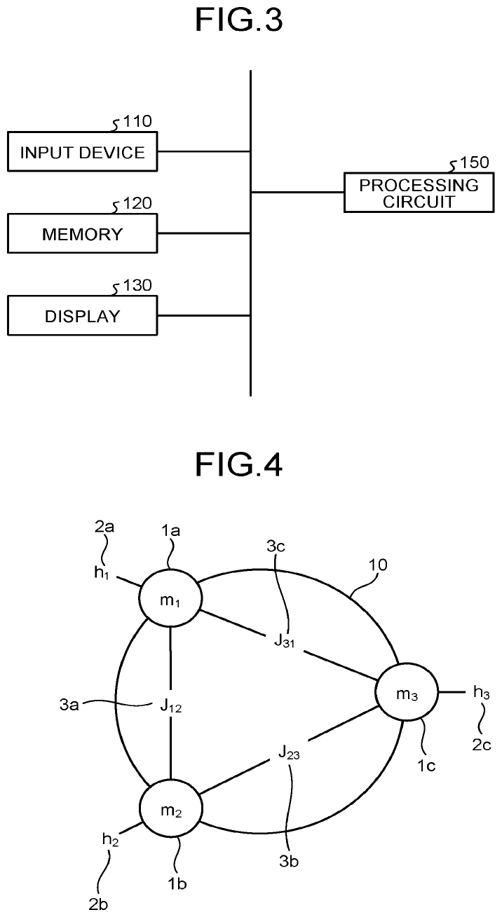

As illustrated in FIG. 3, the processing circuit 150 is connected to an input device 110, a memory 120, a display 130, and other components. The input device 110 is an input device that accepts various instructions and information input from an operator, for example, a pointing device such as a mouse or trackball, a selection device such as a mode switch, or a keyboard. The memory 120 is a memory that stores various types of data, such as input data input to the processing circuit 150 and output data output by the processing circuit 150, and examples thereof include random access memory (RAM), semiconductor memory elements such as flash memory, hard disk, or optical disk. The display 130 is a display on which various analysis results and other information are displayed to a user, and that is a display device such as a liquid crystal display.

Returning to FIG. 1, in the embodiment, each of the processing functions performed by the data input function 151, the input node data retention function 152, the intermediate node data retention function 153, the output node data retention function 154, the data output function 155, and the invertible logic gate processing function 160 (and each of the processing functions constituting the invertible logic gate processing function 160) is stored in the memory 120 in the form of a computer-executable program. The processing circuit 150 is a processor that reads computer programs from the memory 120 and executes the computer programs to implement a function corresponding to each computer program. In other words, the processing circuit 150 with each computer program loaded has each of the functions illustrated within the processing circuit 150 in FIG. 1. It is illustrated in FIG. 1 that these processing functions are implemented by a single processing circuit 150. However, the processing circuit 150 may also be configured with a plurality of independent processors in combination, each of which executes a computer program to implement the function. In other words, each of the functions described above may be configured as a computer program, and a single processing circuit 150 may execute each computer program. As another example, specific functions may be implemented in a dedicated and independent computer program execution circuit.

The data input function 151, the data output function 155, and the invertible logic gate processing function 160 are each an example of a control unit. The input node data retention function 152, the intermediate node data retention function 153, and the output node data retention function 154 are each an example of a retention unit.

The term “processor” used in the above description refers to, for example, central processing unit (CPU), graphical processing unit (GPU), or application specific integrated circuit (ASIC), computer programmable logic devices (for example, simple programmable logic device (SPLD), complex programmable logic device (CPLD), and field programmable gate array (FPGA)), and other circuits. The processor reads and executes the computer programs stored in the memory 120 to implement the functions.

Instead of storing the computer programs in the memory 120, a configuration in which the computer programs are incorporated directly into a circuit of the processor may be adopted. In this case, the processor reads and executes the computer programs incorporated into the circuit of the processor to implement the functions.

The data input function 151 is a function of inputting input data to be calculated. Specifically, the processing circuit 150 acquires input data to be calculated from the input device 110 or the memory 120 by the data input function 151 and inputs the input data to the output nodes 13 in the processing circuit 150. The processing circuit 150 of the embodiment is to solve the inverse problem. That is, input data is input to the output nodes 13, and output data is output from the input nodes 11 and 12.

The data output function 155 is a function of outputting output data of the calculation results to an external device. Specifically, the processing circuit 150 transmits, by the data output function 155, the output data of the calculation results retained at the input nodes 11 and 12 to the memory 120 or causes the display 130 to display the output data of the calculation results.

The processing circuit 150 also retains data of the input nodes 11 and 12, the intermediate nodes 14, and the output nodes 13 by the input node data retention function 152, the intermediate node data retention function 153, and the output node data retention function 154, respectively.

The processing circuit 150 performs processing using the invertible logic gates to solve the inverse problems by the invertible logic gate processing function 160.

Next, an invertible logic gate and a circuit with the invertible logic gate will be briefly described with reference to FIGS. 4 to 10.

In the normal logic gate, when an input signal is input to an input node, an output signal uniquely corresponding to the input signal is output from an output node. For example, in an OR logic gate, in a case in which a signal value of a first input node is “1”, and a signal value of a second input node is “0”, output nodes output signal values “1”, which are output signals uniquely corresponding to these input signals.

In contrast, in the invertible logic gate, input signals that are consistent with given output signals are output with high probability as the input signals. As an example, in an invertible OR logic gate, in a case in which the signal value of the output node is “1”, it may be considered, as a set of the input signal that is consistent with the signal value of this output node, with any one of the following cases: a signal value of the first input node is “1”, and a signal value of the second input node is “0”; the signal value of the first input node is “0”, and the signal value of the second input node is “1”; or the signal value of the first input node is “1”, and the signal value of the second input node is “1”. Thus, in the invertible logic gate, any one set of the signal value of the input node that is consistent with the signal value of the output node is given to the input node with high probability.

Here, unlike the case of the normal logic gate, in the invertible logic gate, the signal value of the input node is not uniquely determined for the signal value of the output node, because there are a plurality of sets of the input signal that is consistent with the signal value of the output node. Thus, in the invertible logic gate, the signal value that is consistent with the signal value of the output node is probabilistically given as the signal value of the input node.

In addition, in the invertible logic gate, any set of the signal value of the input node that is consistent with the signal value of the output node is given to the input node with high probability, but the probability that a signal value of the input node that is inconsistent with the signal value of the output node is given to the input node is not excluded. For example, in the invertible OR logic gate, the probability that the signal value of the first input node is “0”, and the signal value of the second input node is “0” is not excluded even though the signal value of the output node is “1”. In other words, in the invertible logic gate, a relationship between the signal value of the input node and the signal value of the output node as the normal logic gate is not necessarily satisfied at each time.

However, in the invertible logic gate, processing of periodically updating the signal value of each node is performed by the processing described later. In this case, a Hamiltonian described later is introduced for each logic gate to perform processing of differentiating the probability of updating the signal values between the set of the input node and output node that satisfies the logical relationship as the normal logic gate, and the set of the input node and output node that does not satisfy the logical relationship as the normal logic gate. According to this, the set of the input signals that satisfy the logical relationship as the normal logic gate is selected with high probability at a time when a sufficient amount of time has elapsed from the initial state.

That is, in the invertible logic gate, even though the logical relationship between the input node and the output node as the normal logic gate is not necessarily ensured at each time, the set of the input signals that satisfies the logical relationship as the normal logic gate is selected with high probability after a sufficient amount of time has elapsed from the initial state. In this way, it is thought that the invertible logic gate can output an input signal with respect to an output signal. Therefore, the configuration in which the circuit is formed of the invertible logic gates in combination enables output of the input signals to be the given output signals, and the processing circuit 150 to solve the inverse problem.

The logical relationship described above is, for example, a correspondence relationship in inputs and outputs illustrated in the truth tables of logical operations (such as AND, OR, XOR, and NOT). The relationship described herein can also be considered, for example, as a relationship to be satisfied between input and output nodes in units of blocks composed of a plurality of logic gates, rather than in units of logical operations (logic gates). The invertible logic gate may be implemented by predetermined hardware such as CPU, GPU (or ASIC), a computer programmable logic device (for example, SPLD, CPLD, or FPGA), or as software on hardware.

A schematic diagram of an invertible logic gate 10 is illustrated in FIG. 4. That is, the invertible logic gate 10 consisting of three nodes: two nodes of input nodes composed of a first input node 1a and a second input node 1b; and one node of an output node composed of an output node 1c. Here, signal values retained at the first input node 1a, the second input node 1b, and the output node 1c are “0” or “1”. These signal values can also take a spin ½ representation. For example, a signal value of “0” corresponds to a state of m=−1, the downward spin, and a signal value of “1” corresponds to a spin m=1, the upward spin. For example, in a case in which a signal value of the first input node 1a is “0”, a signal value of the second input node 1b is “1”, and a signal value of the output node is “0”, a spin representation of the signal value of the first input node 1a is mᵢ=−1, a spin representation of the signal value of the second input node 1b is m₂=1, and a spin representation of the signal value of the output node 1c is m₃=−1.

The Hamiltonian H_{gate} of the Ising model represented by the following equation (1) is defined for the invertible logic gate 10.

$${H}_{gate} = - {\sum }_{i} {h}_{i} {m}_{i} - {\sum }_{i < j} {J}_{ij} {m}_{i} {m}_{j} . \qquad ( 1 )$$

Here, i and j are the subscripts of each of the nodes, and mᵢ is a spin representation of a signal value of the i-th node. hᵢ is a coefficient for the i-th node, and is a quantity representing the magnetic field about the i-th node in the Ising model. Jᵢⱼ is also a coefficient between the i-th node and the j-th node, and is a quantity representing exchange interaction between the i-th node and the j-th node in the Ising model.

Corresponding to this Hamiltonian, the invertible logic gate 10 retains information corresponding to coefficients 2a, 2b, and 2c, which are respectively coefficients for the nodes, and information corresponding to coefficients 3a, 3b, and 3c, which are coefficients between the nodes, as illustrated in FIG. 4. Specifically, the invertible logic gate 10 retains the coefficients corresponding to the first term on the right side of equation (1) as the coefficients 2a, 2b, and 2c. That is, the invertible logic gate 10 retains the coefficients 2a, 2b, and 2c as the coefficients corresponding to the first term on the right side of equation (1) for first, second, and third nodes, respectively. In addition, the invertible logic gate 10 retains the coefficients corresponding to the second term on the right side of equation (1) as the coefficients 3a, 3b, and 3c. That is, the invertible logic gate 10 retains the coefficients 3a, 3b, and 3c as the coefficients between the first node and the second node, between the second node and the third node, and between the third node and the first node, respectively, the coefficients 3a, 3b, and 3c corresponding to the second term on the right side of equation (1).

The coefficients 2a, 2b, 2c, and coefficients 3a, 3b, 3c are predetermined values depending on the type of the invertible logic gate 10 as a logic gate. These numbers are invariant to changes in time and are independent of a signal value of each node.

Assuming that the invertible logic gate 10 serving as a normal logic gate, these coefficients are designed so that an evaluation value of the Hamiltonian in the state in which the logical relationships to be satisfied between the nodes are satisfied (valid state) is smaller than that in the state in which the logical relationships to be satisfied between the nodes are not satisfied (invalid state). In other words, the Hamiltonian given by equation (1) is designed so that the evaluation value of the Hamiltonian in the valid state in the invertible logic gate 10 is smaller than the evaluation value of the Hamiltonian in the invalid state.

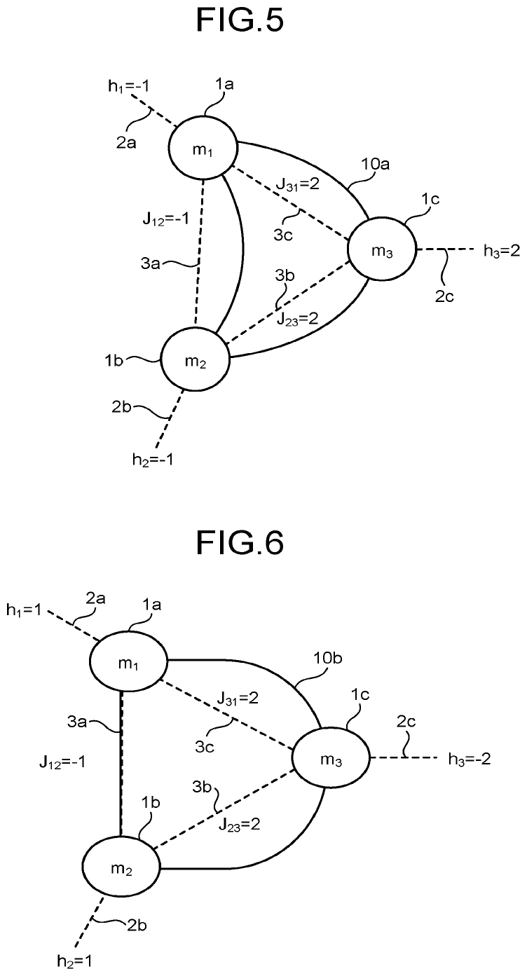

A more specific configuration example of the invertible logic gate will be described with reference to FIGS. 5 and 6. In an invertible OR logic gate 10a illustrated in FIG. 5, the coefficients hᵢ and Jᵢⱼ are represented by the following equations (2) and (3), respectively.

$${h}_{i}^{OR} = [ - \begin{matrix}1 & - 1 & + 2 ]\end{matrix} \qquad ( 2 )$$

$${J}_{ij}^{OR} = [ \begin{matrix}0 & - 1 & + 2 \\ - 1 & 0 & + 2 \\ + 2 & + 2 & 0\end{matrix} ] \qquad ( 3 )$$

That is, as illustrated in FIG. 5, h₁=−1 for the coefficient 2a, h₂=−1 in the coefficient 2b, and h₃=2 for the coefficient 2c, in the invertible OR logic gate 10a. In addition, J₁₂=−1 for the coefficient 3a, J₂₃=2 for the coefficient 3b, and J₃₁=2 for the coefficient 3c, in the invertible OR logic gate 10a.

Furthermore, in an invertible AND logic gate 10b illustrated in FIG. 6, the coefficients hᵢ and Jif are represented by the following equations (4) and (5), respectively.

$${h}_{i}^{AND} = [ + \begin{matrix}1 & + 1 & - 2 ]\end{matrix} , \qquad ( 4 )$$

$${J}_{ij}^{AND} = [ \begin{matrix}0 & - 1 & + 2 \\ - 1 & 0 & + 2 \\ + 2 & + 2 & 0\end{matrix} ] . \qquad ( 5 )$$

That is, as illustrated in FIG. 6, h₁=1 for the coefficient 2a, h₂=1 for the coefficient 2b, and h₃=−2 for the coefficient 2c, in the invertible AND logic gate 10b. In addition, J₁₂=−1 for the coefficient 3a, J₂₃=2 for the coefficient 3b, and J₃₁=2 for the coefficient 3c, in the invertible AND logic gate 10b.

Furthermore, for example, other types of the invertible logic gate 10, such as an invertible XOR logic gate and an invertible NOR logic gate, can also be configured in the same way by adopting appropriately configured Hamiltonian coefficient values.

The Hamiltonian of the invertible logic gate 10 illustrated in equation (1) can be decomposed into the sum of the portion Hᵢ pertaining to the node i in the Hamiltonian, as illustrated in the following equation (6).

$${H}_{gate} = {\sum }_{i} {H}_{i} \qquad ( 6 )$$

Specifically, the portion Hᵢ of the Hamiltonian of the invertible logic gate 10, which pertains to the node i, is represented by the following equation (7).

$${H}_{i} = - {m}_{i} ( {h}_{i} + {\sum }_{j , i \neq j} {J}_{ij} {m}_{j} ) \qquad ( 7 )$$

That is, the Hamiltonian of the invertible logic gate 10 can be decomposed into the sum of components for individual nodes, as appropriate. Each of these components of the Hamiltonian decomposed into components for individual nodes is incorporated into the first term and second term on the right side of equation (8) described later, and used in the processing of updating a signal value at each node.

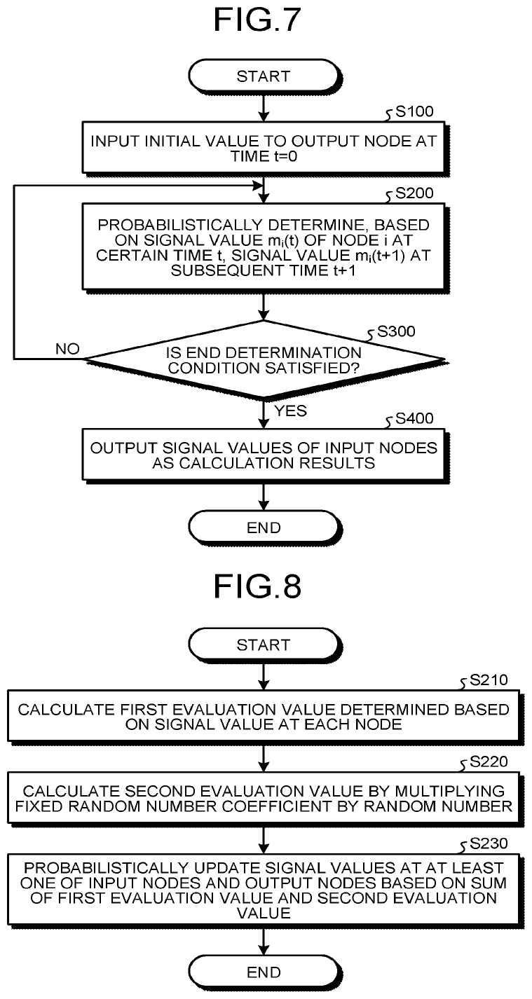

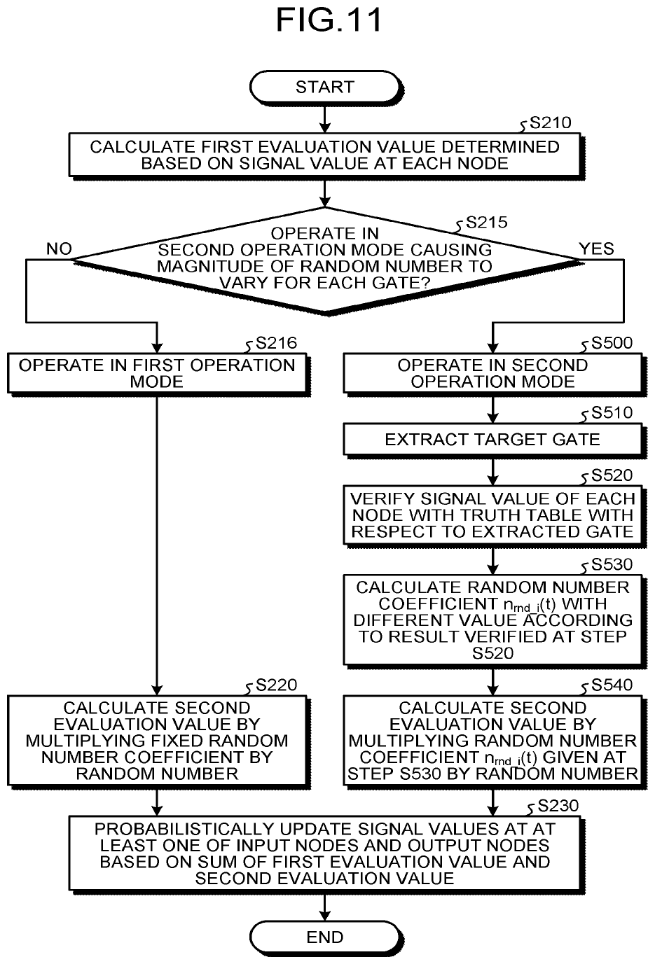

Next, the processing performed at the invertible logic gate 10 will be described with reference to FIGS. 7 and 8. FIG. 7 is a flowchart illustrating a flow of the processing at the invertible logic gate 10 according to the embodiment. FIG. 8 is a flowchart illustrating a flow of the processing performed at step S200 in FIG. 7. In the processing circuit 150 according to the embodiment, the processing at step S200 in FIG. 7, which includes processes other than that illustrated in the flowchart in FIG. 7, is performed, and this point will be explained in detail in the description of FIG. 11 below. Firstly, with excluding this processing, the basic operation of the invertible logic gate 10 will be described below.

In the embodiment, a plurality of the invertible logic gates 10 are usually combined to form the processing circuit 150. The case in which the invertible logic gates 10 are combined is described below, and a case in which the processing circuit 150 is composed of a single invertible logic gate 10 is described herein.

First, at step S100, the processing circuit 150 inputs an initial value to the output node 1c at time t=0 by the data input function 151. Specifically, the processing circuit 150 inputs the initial value to the output node 1c of the invertible logic gate 10 by the data input function 151. As an example, in a case in which the initial value input to the output node 1c is “1” at time t=0, the processing circuit 150 inputs the initial value, “1”, to the output node 1c of the invertible logic gate 10 by the data input function 151. In this case, a signal value of the output node 1c is m₃=1.

The processing then proceeds to step S200, where the processing circuit 150 updates a signal value at each node at regular time intervals. That is, the processing circuit 150 probabilistically determines, based on a signal value mᵢ(t) of the node i at a certain time t, where i is the node number, and a signal value mⱼ(t) of the other node j (the node j is a different node from the node i, and is adjacent to the node i), a signal value mᵢ(t+1) at a subsequent time t+1, by the invertible logic gate processing function 160.

As an example, in FIG. 4, the processing circuit 150 probabilistically determines, based on a signal value mᵢ(t) of the first input node 1a at time t, a signal value m₂(t) of the second input node 1b at time t, and a signal value m₃ (t) of the output node 1c at time t, signal values mᵢ(t+1), m₂(t+1), and m₃(t+T) at the subsequent time t+1, by the invertible logic gate processing function 160.

Specifically, the processing circuit 150 gives, by the invertible logic gate processing function 160, the signal value mᵢ(t+1) of the node i at time t+1 with the following equations (8) to (10).

$${I}_{i} ( t + 1 ) = {h}_{i} + {\sum }_{j} {J}_{ij} \cdot {m}_{j} ( t ) + {n}_{rnd} \cdot {r}_{i} ( t ) , \qquad ( 8 )$$

$$I tan {h}_{i} ( t + 1 ) = \{ \begin{matrix}{I}_{0} - 1 , if I tan {h}_{i} ( t ) + {I}_{i} ( t + 1 ) \geq {I}_{0} \\ - {I}_{0} , else if I tan {h}_{i} ( t ) + {I}_{i} ( t + 1 ) < - {I}_{0} \\ I tan {h}_{i} ( t ) + {I}_{i} ( t + 1 ) , otherwise\end{matrix} \qquad ( 9 )$$

$${m}_{i} ( t + 1 ) = \{ \begin{matrix}1 , & if I tan {h}_{i} ( t + 1 ) \geq 0 \\ - 1 , & otherwise\end{matrix} \qquad ( 10 )$$

Here, in equation (8), t is time, i and j are node numbers, hᵢ is the coefficient for the i-th node in the first term on the right side of equation (1), Jif is the coefficient between the i-th node and the j-th node in the second term on the right side of equation (1), n_{rnd} is a constant that represents the magnitude of the random number, rᵢ(t) is the random number given to the i-th node at time t. That is, function Iᵢ(t) at time t+1 in the i-th node is obtained by the evaluation of the right side of equation (8).

Function Itanhᵢ(t+1) at time t+1 in the i-th node can be evaluated by equation (9) with the function Iᵢ(t). Here, I₀ is a predetermined threshold value. I₀ is a quantity that has the meaning of the inverse of temperature in the spin system. The function Itanhᵢ(t) is a function named in the sense that its behavior is similar to that of the tanh function, but is a function that is determined sequentially by the recursion formula in equation (9), not the tanh function itself.

With the above-described function Itanhᵢ(t), the signal value mᵢ(t+1) at the i-th node at time t+1 is given by equation (10) described above.

The details of such steps are illustrated in FIG. 8. FIG. 8 is a flowchart detailing the processing at step S200 in FIG. 7.

First, at step S210, the processing circuit 150 calculates a first evaluation value determined based on a signal value at each node by the first evaluation value generation function 161.

The first evaluation value generation function 161 has a Hamiltonian coefficient retention function 161a of retaining coefficients of the Hamiltonian for each gate, and a Hamiltonian evaluation function 161b of evaluating the Hamiltonian based on the coefficients of the Hamiltonian retained by the Hamiltonian coefficient retention function 161a. The processing circuit 150 retains values of the coefficient hᵢ for each node and the coefficient Jif between nodes by the Hamiltonian coefficient retention function 161a. The processing circuit 150 also calculates the first evaluation value, which is the sum of the first term on the right side and the second term on the right side of equation (8), based on the values of the retained coefficient hᵢ for each node and the retained coefficient Jif between nodes, by the Hamiltonian evaluation function 161b.

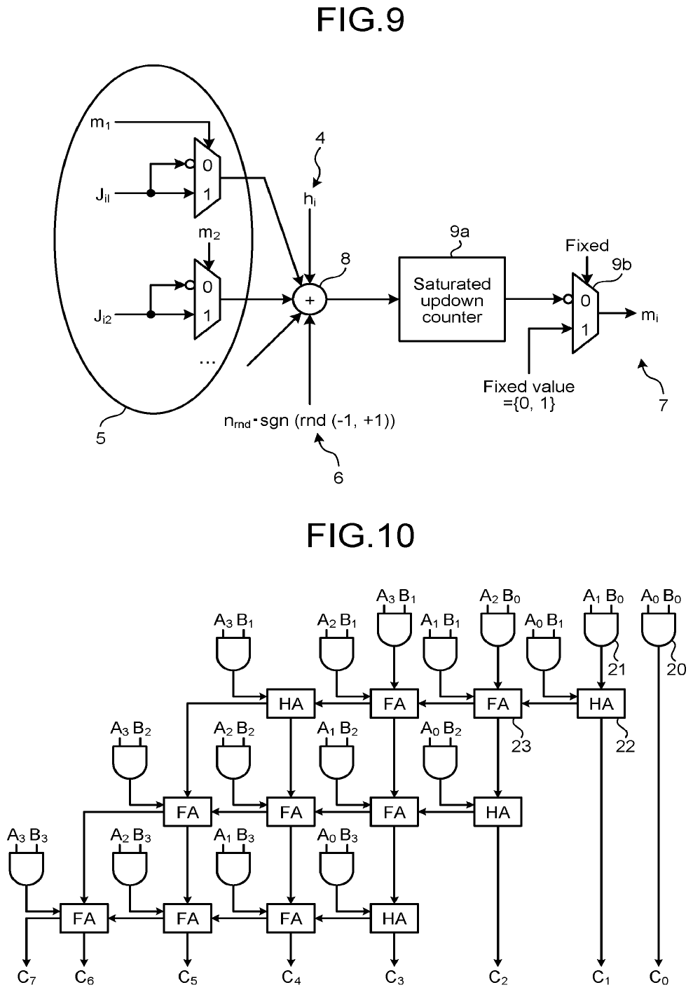

Such a process is illustrated in FIG. 9. In FIG. 9, the processing circuit 150 evaluates the first term on the right side of equation (8) in an area indicated by arrow 4 and evaluates the second term on the right side of equation (8) in an area indicated by enclosure line 5, by the first evaluation value generation function 161. The processing circuit 150 calculates the sum of the first term and the second term on the right side of equation (8) by using an addition circuit 8 functioning as part of the Hamiltonian evaluation function 161b.

Next, at step S220, the processing circuit 150 calculates a second evaluation value by the second evaluation value generation function 162.

Here, the second evaluation value generation function 162 has the target gate determination function 162a, the valid state determination function 162b, the random number coefficient determination function 162c, and the random number generation function 162d. However, regarding the example in FIG. 8, the random number coefficient n_{rnd} is a fixed value. Thus, the target gate determination function 162a, the valid state determination function 162b, and the random number coefficient determination function 162c are not used. Details of these functions will be described with reference to FIG. 11. The random number generation function 162d generates random numbers. That is, the processing circuit 150 generates random number rᵢ(t) represented in the third term on the right side of equation (8) by the random number generation function 162d.

Next, the processing circuit 150 calculates the second evaluation value, which is the third term on the right side of equation (8), by multiplying the fixed random number coefficient n_{rnd} in the third term on the right side of equation (8) by the random number rᵢ(t), by the second evaluation value generation function 162. In an area indicated by arrow 6 in FIG. 9, the processing circuit 150 calculates, by the random number generation function 162d, the second evaluation value in the third term on the right side of equation (8).

Then, at step S230, the processing circuit 150 updates the signal values by the evaluation value addition function 163 and the node data update function 164. The evaluation value addition function 163 is a function of adding the first evaluation value generated by the first evaluation value generation function 161 and the second evaluation value generated by the second evaluation value generation function 162.

That is, the processing circuit 150 generates a value of function Iᵢ(t+1) by adding the first evaluation value, which is the first term and the second term on the right side of equation (8), and the second evaluation value, which is the third term on the right side of equation (8), by the evaluation value addition function 163. As an example, the processing circuit 150 generates a value of function Iᵢ(t+1) by adding an evaluation value of the first term on the right side of equation (8) indicated by arrow 4, an evaluation value of the second term on the right side of equation (8) indicated by enclosure line 5, and an evaluation value of the third term on the right side of equation (8) indicated by arrow 6 by the addition circuit 8 functioning as the evaluation value addition function 163.

The node data update function 164 is a function of updating the signal values based on the value of the generated function Iᵢ(t). That is, the processing circuit 150 updates, based on the value of the function Iᵢ(t) generated by the evaluation value addition function 163, the signal value mᵢ at the i-th node according to equations (9) and (10) by the node data update function 164. As an example, the processing circuit 150 calculates, by using a circuit 9a that performs processing corresponding to equation (9), a value of the function Itanhᵢ based on the value of the function Iᵢ generated by the evaluation value addition function 163. The processing circuit 150 updates, based on a circuit 9b that performs processing corresponding to equation (10), the signal value mᵢ. That is, the circuit 9a and circuit 9b are examples of the node data update function 164.

At step S230, the processing circuit 150 may update the signal values in only some nodes, instead of updating the signal values in all nodes.

As an example, the processing circuit 150 may update the signal values in a forward mode where the signal values of the input nodes are fixed and only the signal value of the output node is updated by the node data update function 164. In this case, the processing circuit 150 may update only the signal value m 3 of the output node 1c, and may fix the signal value mᵢ of the first input node 1a and the signal value m₂ of the second input node 1b and may not perform the update for those signal values by the node data update function 164.

As another example, the processing circuit 150 may update the signal values in a reverse mode where the signal value of the output node is fixed and only the signal values of the input nodes are updated by the node data update function 164. In this case, the processing circuit 150 may update only the signal value mᵢ of the first input node 1a and the signal value m₂ of the second input node 1b by the node data update function 164, and may fix the signal value m₃ of the output node 1c and may not perform the update for the signal value. Furthermore, as another example, the processing circuit 150 can update both the signal value of the output node and the signal values of the input nodes, or combine the forward mode and the reverse mode described above (for example, both modes are alternately performed) by the node data update function 164.

The convergence test function 165 is a function of performing a convergence test, and the calculation accuracy calculation function 166 is a function of calculating calculation accuracy, in each iteration step. Here, the convergence test is a function of determining whether calculation results, that is, signal values at the individual nodes converge to a certain value or not. The term “calculation accuracy” means a numerical value that represents that to what extent the data of the input node, which is a solution candidate for the inverse problem at that time, satisfies the relationship of the inverse problem to be satisfied. The processing circuit 150 may perform the convergence test as appropriate or calculate the calculation accuracy as necessary in each iteration step by the convergence test function 165 or the calculation accuracy calculation function 166.

As described above, at step S200, the processing circuit 150 updates the signal value mᵢ for each node by the node data update function 164.

Returning to FIG. 7, at step S300, the processing circuit 150 determines whether an end determination condition has been satisfied or not by the invertible logic gate processing function 160. Here, the “end determination condition has been satisfied” is, for example, a case of satisfying the convergence test condition regarding the calculation results. That is, the processing circuit 150 determines whether the end determination condition has been satisfied or not by determining whether the calculation results have converged or not by the convergence test function 165. As another end determination condition, in a case in which the signal values are updated a predetermined number of times, the processing circuit 150 may determine that the end determination condition has been satisfied by the invertible logic gate processing function 160. For example, in a case in which the logic gates are present, the end determination condition at step S300 can be defined such that in a case in which the relationship between the signal value of the input node and the signal value of the output node constituting each gate is, as compared to a truth table, in an invalid state with the truth table, the number of gates becomes zero, or can also be defined such that the gates may be present in the invalid state with the truth table to some extent.

In a case in which the processing circuit 150 determines that the end determination condition has not been satisfied by the invertible logic gate processing function 160 (No at step S300), the processing returns to step S200, and the processing circuit 150 updates the signal value mᵢ at each node. In contrast, in a case in which the processing circuit 150 determines that the end determination condition has been satisfied by the invertible logic gate processing function 160 (Yes at step S300), the processing proceeds to step S400.

Next, at step S400, the processing circuit 150 outputs signal values of the input nodes as calculation results by the data output function 155. As an example, the invertible logic gate 10 outputs the signal value of the first input node 1a and the signal value of the second input node 1b as the calculation results. In the invertible logic gate 10, in a case in which assuming that the invertible logic gate 10 for the signal value of each input node is a normal logic gate, the relationship to be satisfied is satisfied, the Hamiltonian, which is the evaluation value used to define the update probability of the signal value mᵢ, is designed to employ a smaller value as compared with a case in which the relationship is not satisfied. As a result, after the time for a sufficient number of cycles has elapsed, the signal value at each input node satisfies the relationship to be satisfied with high probability.

Next, the processing circuit 150 will be described with the case in which the invertible logic gates are combined.

In FIGS. 5 and 6, the invertible AND logic gate and the invertible OR gate are described, and the Hamiltonian is appropriately set to form basic logic gates such as an invertible XOR logic gate, an invertible NOR logic gate, and an invertible NAND logic gate in the same manner. Here, any logic circuit can be represented in combination of the basic logic gates such as an AND gate, an OR gate, and an XOR gate. Accordingly, by employing a configuration in which a circuit is formed with a plurality of basic invertible logic gates in combination for any logic circuit, an inverse problem with respect to the problem represented in the normal logic circuit with a forward problem can be solved. As an example, in a case in which the problem in the forward mode can be represented in combination of the AND gate and the XOR gate, the inverse problem with respect to the forward problem can be solved by using a circuit in which the invertible AND logic gate and the invertible XOR logic gate are combined.

That is, in order to produce a circuit for solving the inverse problem by using the invertible logic gates, the forward problem may be represented in combination of normal logic gates, and the normal logic gates may be then replaced by the corresponding invertible logic gates.

Hereinbelow, such a circuit configuration will be described with a problem of factorizing natural numbers as an example. Here, the problem of factorizing natural numbers refers to a problem of finding, for a given natural number C, a set of natural numbers A and B that satisfies A×B=C. That is, for natural numbers A and B, the processing of calculating the product of A and B is a forward problem, and for the given natural number C, the problem of finding a set of natural numbers A and B that satisfies A×B=C is an inverse problem to the forward problem.

First, considering a solution to the forward problem, for simplicity, with assumption that A and B are natural numbers between equal to or greater than 1 and smaller than 16, and A and B are represented by binary representations, A=A₃×2³+A₂×2²+A₁×2+A₀×2⁰, and B=B₃×2³+B₂×2²+B₁×2¹+B₀×2⁰. Representing A×B with these binary representations and comparing the representations with binary representations of C=C₇×2⁷+C₆×2⁶+C₅×2³+C₄×2⁴+C₃×2³+C₂×2²+C₁×2¹+C₀×2⁰, with taking into account carryovers and the like, enable implementation of a logic circuit that calculates the product of A and B for natural number A and natural number B.

An example of such a logic circuit is illustrated in FIG. 10. Here, A₃, A₂, A₁, and A₀ are binary representations of the natural number A, which are given as inputs. B₃, B₂, B₁, and B₀ are also the binary representations of the natural number B, which are given as inputs. C₇, C₆, C₅, C₄, C₃, C₂, C₁, and C₀ are also the binary representations of the natural number C, which are given as outputs.

Here, a gate 20 and a gate 21 are AND logic gates. A circuit 22 and a circuit 23 are logic circuits known as Half-Adder and Full-Adder, respectively, which can be implemented in combination of predetermined logic gates. For example, the circuit 22 and the circuit 23 are circuits that can be implemented with a predetermined combination of the AND gates and the XOR gates. Therefore, as an example, an invertible Half-Adder circuit can be generated by the replacement of the AND gate with the invertible AND logic gate, and the replacement of the XOR gate with the invertible XOR logic gate in the circuit configuration of the circuit 22, which serves as the Half-Adder. In addition, as an example, an invertible Full-Adder circuit can be generated by the replacement of the AND gate with the invertible AND logic gate, and the replacement of the XOR gate with the invertible XOR logic gate in the circuit configuration of the circuit 23, which serves as the Full-Adder.

Therefore, in a multiplication circuit illustrated in FIG. 10, an invertible multiplication circuit (factorization circuit) can be generated by the replacement of the logic gate of each component with the invertible logic gate.

Returning to FIG. 2, the node configuration of the invertible multiplication circuit 15 will be described. The output nodes 13 are nodes to which the initial input of the inverse problem is input. The processing circuit 150 inputs the binary representations of the natural number C to be factorized into the output nodes 13 by the data input function 151. The input nodes 11 and the input nodes 12 are nodes from which the calculation results are output. The processing circuit 150 outputs the binary representations of the factorized natural number A from the input nodes 11 and outputs the binary representations of the factorized natural number B from the input nodes 12 by the data output function 155. The intermediate nodes 14 are nodes in the invertible multiplication circuit 15 excluding the input nodes 11 and 12 and the output nodes 13. The intermediate nodes 14 retain the results of various intermediate calculations.

Referring again to FIGS. 7 and 8, each flow of processing performed by the processing circuit 150 in which the invertible logic gates are combined will be described.

First, at step S100, the processing circuit 150 inputs an initial value to the output nodes at time t=0 by the data input function 151. As an example, the processing circuit 150 inputs the binary representations of the natural number C to be factorized into the output nodes 13 of the invertible multiplication circuit 15 by the data input function 151.

The processing then proceeds to step S200, where the processing circuit 150 updates a signal value at each node at regular time intervals. Here, “each node” refers to each of the input nodes 11, the input nodes 12, and the intermediate nodes 14, which are nodes other than the output nodes 13. The processing circuit 150 probabilistically updates signal values of these nodes by the invertible logic gate processing function 160. The processing circuit 150 can fix the signal values of the output nodes 13 without updating the signal values.

Here, the processing circuit 150 updates the signal value at each node with equations (8) to (10), and in the evaluation of the right side of equation (8) for the signal value at each node in the circuit formed of the invertible logic gates in combination, the first term and the second term on the right side of equation (8) are evaluated by using the contribution of a portion of the Hamiltonian in the entire circuit, which is determined by the sum of the individual logic gates, the portion being related to each of the nodes.

That is, in the case in which the logic gates are combined to form a single circuit, the Hamiltonian H of the entire circuit can be represented by the following equation (11).

$$H = {\sum }_{k} {H}_{{Gate}_{k}} \qquad ( 11 )$$

Here, k is the number assigned to each invertible logic gate and H_{Gate_k} is the Hamiltonian of the k-th invertible logic gate. The Hamiltonian of each invertible logic gate is in the form of equation (1). Thus, the Hamiltonian can be separated into node-specific components, as in equations (6) and (7). Therefore, the Hamiltonian of the entire circuit in equation (11) can also be separated into node-by-node components. The Hamiltonian component for each node is changed to the first term and the second term on the right side of equation (8), and substituted by using equations (9) and (10); thereby the processing circuit 150 updates the signal value at each node by the invertible logic gate processing function 160.

That is, at step S210, the processing circuit 150 calculates the first evaluation value, which is the contribution for each node in the Hamiltonian of the entire circuit, by the first evaluation value generation function 161.

Next, at step S220, the processing circuit 150 generates random number rᵢ(t) represented in the third term on the right side of equation (8) by the random number generation function 162d. Next, the processing circuit 150 calculates the second evaluation value, which is the third term on the right side of equation (8), by multiplying the fixed random number coefficient n_{rnd} in the third term on the right side of equation (8) by the random number rᵢ(t), by the second evaluation value generation function 162.

Next, at step S230, the processing circuit 150 adds the first evaluation value and the second evaluation value by the evaluation value addition function 163 to generate a value of the function Iᵢ(t+1). Next, the processing circuit 150 updates, based on the value of the function Iᵢ(t+1) generated, the signal value mᵢ in the i-th node according to equations (9) and (10) by the node data update function 164.

As described above, at step S200, the processing circuit 150 updates the signal value mᵢ for each node by the node data update function 164.

Returning to FIG. 7, at step S300, the processing circuit 150 determines whether an end determination condition has been satisfied or not by the invertible logic gate processing function 160.

In a case in which the processing circuit 150 determines that the end determination condition has not been satisfied by the invertible logic gate processing function 160 (No at step S300), the processing returns to step S200, and the processing circuit 150 updates the signal value mᵢ at each node. In contrast, in a case in which the processing circuit 150 determines that the end determination condition has been satisfied by the invertible logic gate processing function 160 (Yes at step S300), the processing proceeds to step S400.

Next, at step S400, the processing circuit 150 outputs signal values of the input nodes as calculation results by the data output function 155. As an example, the processing circuit 150 outputs the signal values of the input nodes 11 and the input nodes 12 as calculation results by the data output function 155.

Next, the background of the embodiment will be described.

In the calculation with the invertible logic gates, there is a problem that the calculation result is stuck in a local minimum energy state, and as a result, a global minimum energy state, which is the true calculation result, may not be reached. For example, it is assumed that a plurality of logic gates (second logic gates) are adjacent to a logic gate (hereinafter, referred to as a first logic gate) that does not satisfy the logical relationship to be satisfied by the original logic gate, and each node in these second logic gates satisfies the logical relationship to be satisfied by the original logic gate.

In this case, it is assumed that signal values of nodes in the first logic gate are changed in order for each node in the first logic gate to satisfy the relevant logical relationship. The second logic gates may no longer satisfy the logical relationship to be satisfied by the original logic gate as a result of a change in the signal values of the nodes in the first logic gate, and as a result, the energy of that state may be evaluated as a high energy state. Thus, even though a further change of the signal value at each node in the second logic gates results in a global low energy state, the probability of reaching such a state is low, and the true calculation results may not be obtained.

The above-described processing circuit 150 is based on this background. That is, the processing circuit 150 according to the embodiment is formed of the logic gates in combination each of which probabilistically determines, based on signal values of one or two or more input nodes and output nodes at a certain time, signal values at at least one of the input nodes and the output nodes at a subsequent time. Here, the processing circuit 150 can control the signal values based on the relationship to be satisfied between at least some nodes of the input nodes and the output nodes by the invertible logic gate processing function 160. The processing circuit 150 may also be formed in combination of the logic gates that probabilistically determine, based on signal values at the input nodes and the output nodes at a certain time, signal values at both the input nodes and the output nodes at a subsequent time. In a circuit with the logic gates gathered, as illustrated in FIGS. 2 and 10, the case in which the gate output is plural, that is, a plurality of the output nodes are provided can also be included in the present embodiment. The processing circuit 150 can control the signal values based on the relationship to be satisfied between some nodes of the input nodes and the output nodes, or may control the signal values based on the relationship to be satisfied between all of nodes of the input nodes and the output nodes.

In addition, the logic gate according to the embodiment probabilistically determines, based on signal values of one or two or more input nodes and output nodes at a certain time, signal values at at least one of the input nodes and the output nodes at a subsequent time, and includes a control unit configured to control the signal values based on a relationship to be satisfied between at least some nodes of the input nodes and the output nodes.

Furthermore, an arithmetic processing method according to the embodiment includes performing arithmetic processing of probabilistically determining, based on signal values of one or two or more input nodes and output nodes at a certain time, a signal value at at least one of the input nodes and output nodes at a subsequent time, and controlling the signal values during the arithmetic processing based on a relationship to be satisfied between at least some nodes of the input nodes and the output nodes.

Furthermore, a computer program according to the embodiment causes a computer to execute arithmetic processing of probabilistically determining, based on signal values of one or two or more input nodes and output nodes at a certain time, signal values at at least one of the input nodes and the output node at a subsequent time, and causes the computer to execute processing of controlling the signal values during the arithmetic processing based on a relationship to be satisfied between at least some nodes of the input nodes and the output nodes.

That is, in the embodiment, the processing circuit 150 performs, at step S200 of FIG. 7, the processing illustrated in FIG. 11 instead of the processing illustrated in FIG. 8 by the invertible logic gate processing function 160. Specifically, the processing circuit 150 probabilistically updates the signal values of the nodes while additionally performing the processing at step S215 and steps S500 to S540 by the invertible logic gate processing function 160. Therefore, the processing circuit 150 can prevent the signal values from getting caught and stuck in the local minimum energy state during time evolution. As a result, the convergence of the calculation results can be improved, and the probability of the calculation results reaching the stable global minimum energy state can be improved. That is, the processing circuit 150 according to the embodiment can improve the performance in circuits that can solve inverse problems.

The term “some nodes of the input nodes and the output nodes” described herein means a node serving as the first input node 1a, the second input node 1b, or the output node 1c of any of the invertible logic gates 10 constituting the processing circuit 150. That is, for example, in the case of the invertible multiplication circuit 15 in FIG. 2, not only the input nodes 11 and 12, and the output nodes 13 but also the intermediate nodes 14 are nodes serving as the first input node 1a, the second input node 1b, or the output node 1c of any of the invertible logic gates 10, so that the nodes are included in “some nodes of the input nodes and the output nodes” described herein.

The processing circuit 150 according to the embodiment is formed of one or more invertible logic gates 10 in combination, and used in calculations to solve the inverse problem. That is, the processing circuit 150 according to the embodiment is formed of one or more the logic gates in combination each of which probabilistically determines, based on signal values of one or two or more input nodes and output nodes at a certain time t, signal values at at least one of the input nodes and the output nodes at a subsequent time t+1.

The basic flow from the input of the initial data to the output of the calculation results has already been illustrated in FIG. 7. As illustrated at step S200, the processing circuit 150 probabilistically determines, based on the signal value mᵢ(t) at time t, the signal value mᵢ(t+1) at the subsequent time t+1 by the invertible logic gate processing function 160. Here, in the embodiment, instead of FIG. 8, the processing at step S200 in FIG. 7 is performed based on the processing illustrated in FIG. 11.

Here, the processing circuit 150 according to the embodiment updates the signal values based on the following equations (12) and (13) instead of equation (8). In other words, the processing circuit 150 updates the signal values based on equations (12), (13), (9), and (10).

$${I}_{i} ( t + 1 ) = {h}_{i} + {\sum }_{j} {J}_{ij} \cdot {m}_{j} ( t ) + {{n}_{rnd \_ i} ( t )}_{i ∈ {Gate}_{k}} \cdot {r}_{i} ( t ) , \qquad ( 12 )$$

$${{n}_{rnd \_ i} ( t )}_{i ∈ {Gate}_{k}} = \{ \begin{matrix}{ln}_{rnd ,} & if {Gate}_{k} is invalid \& \\ & t ( mod {T}_{INTVL} ) ≡ 0 \\ {n}_{rnd ,} & otherwise\end{matrix} \qquad ( 13 )$$

In equation (12), n_{rnd_i}(t) is the magnitude of the random number, similar to n_{rnd} in equation (8), but in the embodiment, is not a constant and has a different value for each node i, and depends on time t. The third term on the right side of equation (12) indicates that the evaluation value of the third term on the right side is added to the right side only in a case in which the node i is included in a predetermined gate. That is, equation (12) is similar to equation (8) in terms of the first term and the second term on the right side, but it is indicated that the magnitude of the random term given by the third term on the right side can employ a different value depending on the node i and time t, and such processing is performed only for a predetermined gate.

Equation (13) also indicates the magnitude of such a random term illustrated in the third term on the right side of equation (12). Here, T_{INTVL} is a predetermined time interval, l is a constant, and n_{rnd} is a fixed value of the random number. That is, equation (13) means that the magnitude of the given random term is a result value obtained by multiplying the fixed random number n_{rnd} by the constant 1 only in a case in which a predetermined gate (Gate k) is invalid, and time t is a multiple of a predetermined time interval T_{INTVL}, and in other cases, the magnitude of the random term is the fixed value n_{rnd}. That is, equation (13) means that only in the case in which a state of the predetermined gate is invalid, and time t is a multiple of the predetermined time interval T_{INTVL}, the magnitude of the given random term is made different with other cases. The constant 1 is usually selected to be a value greater than 1, that is, a large random term is given only in the case in which the state of the predetermined logic gate is invalid, and time t is a multiple of the predetermined time interval T_{INTVL}.

In other words, the processing circuit 150 according to the embodiment gives the large random term to the nodes to increase the inversion probability only in the case in which the state of the predetermined logic gate is invalid, and time t is a multiple of the predetermined time interval T_{INTVL}, thereby performing the processing that enables the quick escape of the state of the system from the local minimum energy state. In a case in which it is predetermined at what timing the large random term is given to the node to increase its inversion probability, the inversion probability of the node may be increased other than the case in which time t is a multiple of the predetermined time interval T_{INTVL}. Thus, in the present embodiment, in a case in which the logic gate is “invalid” as compared to a case in which the state of the logic gate configured to include the input nodes and the output nodes is “valid”, the processing of adding a larger random value (in other words, a larger noise) to the nodes of the logic gate is performed to invert at least one of the input value and the output value with higher probability (for example, updating the value to −1 in a case in which the input value is 1).

Whether the predetermined logic gate is valid or invalid is determined depending on, for example, whether the logic gate satisfies the relationship to be satisfied or not. That is, in a case in which the relationship to be satisfied under the assumption that an invertible logic gate is the normal logic gate is satisfied, the invertible logic gate is in a valid state, and in a case in which the relationship to be satisfied under the assumption that an invertible logic gate is the normal logic gate is not satisfied, the invertible logic gate is in an invalid state. As an example, in an invertible AND gate, in a case in which input nodes are “1” and “1” and an output node is “1”, the invertible AND gate is in the valid state, and in a case in which the input nodes are “1” and “0” and the output node is “1”, the invertible AND gate is in the invalid state.

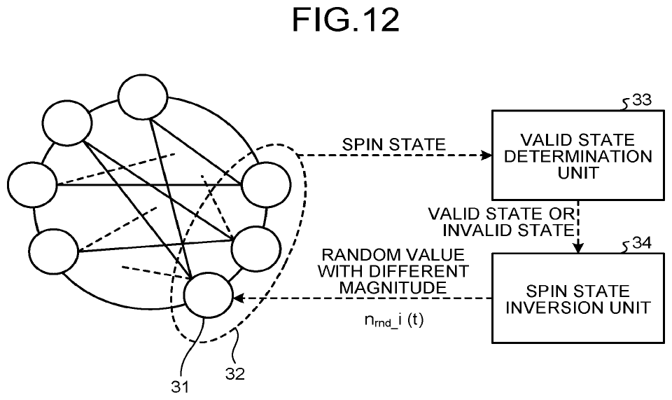

According to the above description, the flow of processing performed by the processing circuit 150 according to the embodiment will be described with reference to FIGS. 11 and 12.

As aforementioned, regarding the first term and the second term on the right side of equation (12), the same processing as in FIG. 8 is performed on the evaluation values used in the processing of updating the signal values, except for the random number term. That is, at step S210, the processing circuit 150 evaluates the first term and the second term on the right side of equation (12), thereby calculating the first evaluation value, which is the contribution for each node in the Hamiltonian of the entire circuit, by the first evaluation value generation function 161.

Here, in the embodiment, as can be seen from the fact that in equation (13), a value of the left side of equation (13) is different from n_{rnd} only in a case in which t is a multiple of T_{INTVL}, the processing circuit 150 probabilistically updates, by the invertible logic gate processing function 160, the signal value mᵢ while switching between a first operation mode and a second operation mode, in which in the first operation mode, the magnitude of random value n_{rnd} given to at least one of the input nodes and the output nodes is fixed, and in the second operation mode, the magnitude of random value n_{rnd_i}(t) given to at least one of the input nodes and the output nodes varies between some nodes of the input nodes and the output node (for example, between some nodes of the input nodes 11 and 12, the intermediate nodes 14, and the output nodes 13) based on the relationship to be satisfied.

As an example, the processing circuit 150 probabilistically updates, by the invertible logic gate processing function 160, the signal value mᵢ in the second operation mode at a certain time period T_{INTVL}, and probabilistically updates the signal value mᵢ in the first operation mode at a time other than a time when operating in the second operation mode.

That is, while the second operation mode described herein has the advantage of preventing calculation results from being trapped in the local low-energy state, too-frequent activation of the second operation mode may cause a negative impact on the convergence of the calculation results. Thus, the processing circuit 150 according to the embodiment can also activate the second operation mode only at a certain time period T_{INTVL}, instead of activating the second operation mode every time when the signal value is updated. Typically, a value of T_{INTVL}=6 or T_{INTVL}=10 is selected, for example.

That is, at step S215, the processing circuit 150 determines whether to activate the second operation mode that causes the magnitude of the random number to vary for each gate, by the invertible logic gate processing function 160. As an example, the processing circuit 150 activates the second operation mode only every certain time period T_{INTVL} by the invertible logic gate processing function 160. As an example, in a case in which time t is an integer multiple of T_{INTVL} (Yes at step S215), the processing circuit 150 causes, by the invertible logic gate processing function 160, the processing to proceed to step S500, and the processing circuit 150 performs the processing at steps S510 to S540 (second operation mode). On the other hand, in a case in which time t is other than an integer multiple of T_{INTVL} (No at step S215), the processing circuit 150 causes, by the invertible logic gate processing function 160, the processing to proceed to step S216, and the processing circuit 150 performs the processing at step S220 (first operation mode). The redundant description will be omitted because the processing at step S220 is similar to the processing already described in FIG. 8.

Next, the processing of the second operation mode will be described with appropriate reference to FIG. 12. First, at step S510, the processing circuit 150 extracts logic gates that perform processing at steps S520 to S540 by the target gate determination function 162a of the second evaluation value generation function 162. Here, as an example, in FIG. 12, the processing circuit 150 extracts predetermined invertible logic gates in a range indicated by, for example, an extraction range 32 as the logic gates that perform the processing at steps S520 to S540 by the target gate determination function 162a. As another example, the processing circuit 150 may extract all gates as the logic gates that perform the processing at steps S520 to S540 by the target gate determination function 162a. Furthermore, step S520 can also be omitted in a case in which, at the time of performing step S210, the signal value of each node has already been verified with the truth table with respect to the extracted gates. In such a case, the random number coefficients of different values according to the results of the verification at step S210 are determined through the processing at S530.

Next, at step S520, the processing circuit 150 determines, by the valid state determination function 162b, whether the invertible logic gates extracted at step S510 satisfy the relationship to be satisfied between some nodes of the input nodes and the output nodes. As an example, the processing circuit 150 determines, by the valid state determination function 162b, whether the invertible logic gates extracted at step S510, that is, the logic gates in the assumption that the invertible logic gates are the normal logic gates satisfy the relationship to be satisfied between the nodes. That is, the relationship to be satisfied between some nodes of the input nodes and the output nodes is determined based on the relationship to be satisfied by the logic gates, for example. Instead of determining whether the invertible logic gates satisfy the relationship to be satisfied between some nodes of the input nodes and the output nodes, it may be determined whether the invertible logic gates satisfy the relationship to be satisfied between all of the input nodes and the output nodes that constitute the invertible logic gates.

As more specific processing, the processing circuit 150 performs the verification of the signal value of each node for the logic gates extracted at step S510 with the truth table by the valid state determination function 162b, and determines that the logic gates satisfy the relationship to be satisfied and the state thereof is valid in a case in which the signal values are matched with the truth table. In contrast, the processing circuit 150 performs the verification of the signal value of each node for the logic gates extracted at step S510 with the truth table by the valid state determination function 162b, and determines that the logic gates do not satisfy the relationship to be satisfied and the state thereof is invalid in a case in which the signal values are not matched with the truth table.

As an example, in FIG. 12, in a case in which a gate pertaining to the nodes 31 included in the extraction range 32 is an invertible AND gate, the input nodes are “1” and “1”, and the output node is “1”, the processing circuit 150 determines that the invertible AND gate is valid as a valid state determination unit 33 by the valid state determination function 162b. In addition, in the case in which the gate pertaining to the nodes 31 is the invertible AND gate, the input nodes are “1” and “0”, and the output node is “1”, the processing circuit 150 determines that the invertible AND gate is invalid as the valid state determination unit 33 by the valid state determination function 162b.

As described above, the term “some nodes of the input nodes and the output nodes” described herein means some nodes of the input nodes and the output nodes of any of the invertible logic gates 10 constituting the processing circuit 150. Thus, for example, in the case of the invertible multiplication circuit 15 in FIG. 2, the intermediate nodes 14 and other nodes are nodes serving as the input nodes or the output nodes of any of the invertible logic gates, so that the nodes are included in “some nodes of the input nodes and the output nodes” described herein.

Next, at step S530, the processing circuit 150 calculates the random number coefficient n_{rnd_i}(t) with a different value according to the result determined at step S520 by the random number coefficient determination function 162c. As an example, the processing circuit 150 calculates the random number coefficient n_{rnd_i}(t) with a different value based on the result of the verification of the signal value of each node with the truth table at step S520 by the random number coefficient determination function 162c.

Specifically, the processing circuit 150 applies the upper value of equation (13) to nodes pertaining to the logic gate determined to be invalid at step S520 by the random number coefficient determination function 162c, and calculates a value obtained by multiplying the fixed value n_{rnd} by the constant 1 as the random number coefficient n_{rnd_t}(t). In contrast, the processing circuit 150 applies the lower value of equation (13) to nodes pertaining to the logic gate determined to be valid at step S520 by the random number coefficient determination function 162c, and calculates the fixed value n_{rnd} as the random number coefficient n_{rnd_i}(t).

As the value of the constant 1, a value greater than 1 is usually used. In this case, by the random number coefficient determination function 162c, the processing circuit 150 gives at least one of the input nodes and the output nodes a larger random value in a case in which the signal values at the input nodes and the output nodes are not matched with the truth table to be satisfied by the logic gate as compared with a case in which the signal values are matched with the truth table.

Next, at step S540, the processing circuit 150 generates random number rᵢ(t) represented in the third term on the right side of equation (12) by the random number generation function 162d. Next, the processing circuit 150 calculates the second evaluation value, which is the third term on the right side of equation (12), by multiplying the random number coefficient n_{rnd_i}(t) given at step S530 by the random number rᵢ(t), by the second evaluation value generation function 162.

Next, at step S230, the processing circuit 150 generates a value of function Iᵢ(t+1) by adding the first evaluation value, which is the sum of the first term and the second term on the right side of equation (12), and the second evaluation value, which is the third term on the right side of equation (12), by the evaluation value addition function 163. Next, the processing circuit 150 updates, based on the value of the function Iᵢ(t+1) generated, the signal value mᵢ(t) in the i-th node according to equations (9) and (10) by the node data update function 164. Thus, as illustrated in FIG. 12, a spin state inversion unit 34 as the node data update function 164 updates the value of the signal value mᵢ(t) at the nodes included in the extraction range 32 based on the information acquired from the valid state determination unit 33.

As described above, the processing circuit 150 controls the signal value mᵢ(t) based on the relationship to be satisfied between some nodes of the input nodes and the output nodes by the invertible logic gate processing function 160. That is, the processing circuit 150 determines, by the invertible logic gate processing function 160, the magnitude of the random value n_{rnd_i}(t) to be given to at least one of the input nodes and the output nodes based on the relationship to be satisfied between some nodes of the input nodes and the output nodes, thereby probabilistically updating the signal value mᵢ(t). Specifically, the processing circuit 150 probabilistically updates the signal values at at least one of the input nodes and the output nodes based on the sum of the evaluation value determined based on the signal values mᵢ(t) at the input nodes and the output nodes and the random number generated based on the magnitude of the random value n_{rnd_i}(t).

The embodiment is not limited thereto. In the embodiment, in the case of performing the processing of determining whether the relationship to be satisfied between the nodes is satisfied at step S520, it will be described that the signal values of the nodes are determined in units of the logic gates. However, the embodiment is not limited thereto, and at step S520, the processing circuit 150 may determine whether or not the relationship to be satisfied between nodes is satisfied in units of blocks of the logic gates by the second evaluation value generation function 162.

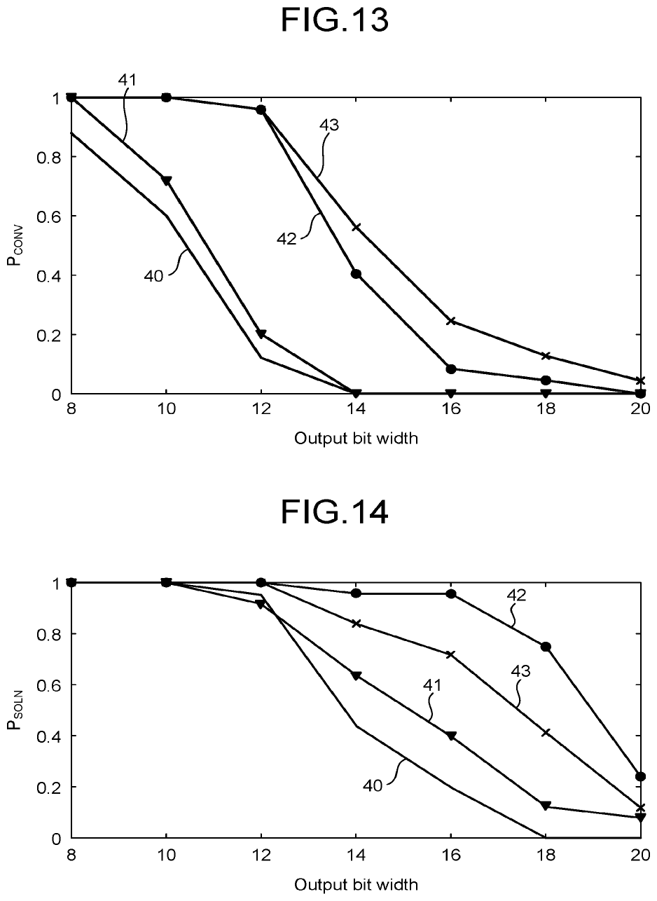

In FIGS. 13 and 14, the performance of a method performed by the processing circuit 150 according to the embodiment is illustrated. Convergence probability P_{CONV} (FIG. 13) and correct answer reaching probability P_{SOLN} (FIG. 14) are illustrated in FIGS. 13 and 14 after 3200 cycles of calculation for each of the comparison method and the method according to the embodiment in a case in which the output bit width of the number to be factorized in the factorization problem is changed.

Here, a graph 40 and a graph 41 represents comparative examples, while a graph 42 and a graph 43 represents the methods used in the embodiment.

The graph 40 is a result of calculation using the method illustrated in FIG. 8, and the graph 41 is a result of calculation at step S220 of FIG. 8, with the second evaluation value calculated only with a certain probability, and with the second evaluation value set to zero in other cases. The graph 42 and the graph 43 are both results of calculation performed by using the method illustrated in FIG. 11, but at step S215, the time interval for activating the second operation mode is different. That is, in the calculation pertaining to the graph 42, the processing circuit 150 activated the second operation mode every 6 cycles, whereas in the calculation pertaining to the graph 43, the processing circuit 150 operated in the second operation mode every 10 cycles.

It can be seen in FIG. 13 that the convergence of calculation results is greatly improved in the method according to the embodiment as compared to the method in the comparative example. In addition, it can be seen in FIG. 14 that the probability of obtaining correct results is greatly improved in the method according to the embodiment as compared to the method in the comparative example.

According to at least one embodiment described above, the performance can be improved in the circuits that can solve the inverse problems.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A processing circuit comprising a plurality of logic gates in combination each of which is configured to probabilistically determine, based on signal values of one or two or more input nodes and output nodes at a certain time, signal values at at least one of the input nodes and the output nodes at a subsequent time, wherein
the processing circuit controls the signal values based on a relationship to be satisfied between at least some nodes of the input nodes and the output nodes.

2. The processing circuit according to claim 1, wherein the processing circuit determines a magnitude of a random value given to at least one of the input nodes and the output nodes based on the relationship to probabilistically update the signal values.

3. The processing circuit according to claim 2, wherein the processing circuit probabilistically updates the signal values at at least one of the input nodes and the output nodes based on an evaluation value determined based on the signal values at the input nodes and the output nodes.

4. The processing circuit according to claim 3, wherein the processing circuit probabilistically updates the signal values at at least one of the input nodes and the output node based on a sum of a random number generated based on the magnitude of the random value and the evaluation value.

5. The processing circuit according to claim 2, wherein the relationship to be satisfied between at least some nodes of the input nodes and the output nodes is determined based on a relationship to be satisfied by the logic gates.

6. The processing circuit according to claim 2, wherein the processing circuit gives at least one of the input nodes and the output nodes a larger random value in a case in which the signal values at the input nodes and the output nodes are not matched with a truth table to be satisfied by the logic gates as compared with a case in which the signal values are matched with the truth table.

7. The processing circuit according to claim 2, wherein
the processing circuit probabilistically updates the signal values while switching between a first operation mode and a second operation mode, in the first operation mode, the magnitude of the random value given to at least one of the input nodes and the output nodes is fixed, and in the second operation mode, the magnitude of the random value given to at least one of the input nodes and the output nodes varies based on the relationship.

8. The processing circuit according to claim 7, wherein the processing circuit probabilistically updates the signal values in the second operation mode at a certain time period, and probabilistically updates the signal values in the first operation mode at a time other than a time when operating in the second operation mode.

9. A logic gate that probabilistically determines, based on signal values of one or two or more input nodes and output nodes at a certain time, signal values at at least one of the input nodes and the output nodes at a subsequent time, wherein
the logic gate controls the signal values based on a relationship to be satisfied between at least some nodes of the input nodes and the output nodes.

10. The logic gate according to claim 9, wherein the logic gate determines a magnitude of a random value given to at least one of the input nodes and the output nodes based on the relationship to probabilistically update the signal values.

11. An arithmetic processing method comprising:
performing arithmetic processing of probabilistically determining, based on signal values of one or two or more input nodes and output nodes at a certain time, signal values at at least one of the input nodes and the output nodes at a subsequent time, and
controlling the signal values during the arithmetic processing based on a relationship to be satisfied between at least some nodes of the input nodes and the output nodes.

12. A non-transitory computer readable medium storing a computer program that causes a computer to execute:
arithmetic processing of probabilistically determining, based on signal values of one or two or more input nodes and output nodes at a certain time, signal values at at least one of the input nodes and the output nodes at a subsequent time, and
processing of controlling the signal values during the arithmetic processing based on a relationship to be satisfied between some nodes of the input nodes and the output nodes.
